(19) United States
(12) Patent Application Publication
(10) Pub. No.: US 2018/0362389 A1
(43) Pub. Date: Dec. 20, 2018

(54) APPARATUS AND METHOD FOR MANUFACTURING BENT OPTICAL FIBER

(71) Applicant: SUMITOMO ELECTRIC INDUSTRIES, LTD., Osaka (JP)

(72) Inventor: Takuya NANJO, Osaka (JP)

(73) Assignee: SUMITOMO ELECTRIC INDUSTRIES, LTD., Osaka (JP)

(21) Appl. No.: 16/009,249

(22) Filed: Jun. 15, 2018

(30) Foreign Application Priority Data
Jun. 19, 2017 (JP) 2017-119451

(51) Int. Cl. C03B 37/15

(52) U.S. Cl. CPC C03B 37/15; C03B 2203/02

(57) ABSTRACT

Provided are an apparatus and a method for manufacturing a bent optical fiber. The apparatus and the method make the temperature distribution between irradiated surfaces and rear surfaces of optical fibers and between the optical fiber in the middle and the optical fibers at the both sides uniform when forming a bent portion by using an infrared laser. An apparatus for manufacturing a bent optical fiber formed of an optical fiber having a bent portion includes a bending formation mechanism that holds the optical fiber and forms the bent portion, a fiber feeding mechanism that feeds the optical fiber toward the bending formation mechanism, a light-source mechanism including a light source that emits laser to a portion of the periphery of the optical fiber in which the bent portion is formed, and a rear reflective member disposed to face the light source with the optical fiber interposed therebetween.

### BACKGROUND OF THE INVENTION

### Field of the Invention

The present invention relates to an apparatus for manufacturing a bent optical fiber that includes a bent portion in which bending stress has been decreased and a method for manufacturing the bent optical fiber.

### Description of the Related Art

In order to optically connect an electronic substrate and an internal wiring line of a device or an external transmission path to each other, an optical connecting component that includes an embedded optical fiber is used. With the reduction in the sizes of optical modules that are mounted onto electronic substrates, there has been a demand for reduction in the heights of optical fibers that are used in the vicinity of such optical modules. Thus, International Publication No. 2015/076105 discloses a technology for manufacturing a bent optical fiber by radiating an infrared laser beam.

### SUMMARY OF THE INVENTION

Accordingly, it is an object of the present invention to provide an apparatus for manufacturing a bent optical fiber that includes a bent portion in which bending stress has been decreased and a method for manufacturing the bent optical fiber, the apparatus and the method being capable of reducing the temperature difference between an irradiated surface of an optical fiber that is to be irradiated with an infrared laser beam and a rear surface of the optical fiber that is opposite to the irradiated surface when causing the optical fiber to have a bent portion by using the infrared laser beam and the temperature difference between, among a plurality of optical fibers that are arranged side by side, the optical fiber positioned in the middle and the optical fibers positioned at the both sides when causing each of the plurality of optical fibers to have a bent portion.

A manufacturing apparatus according to the present invention for manufacturing a bent optical fiber that includes a bent portion in which bending stress has been decreased includes a bending formation mechanism, a fiber feeding mechanism, a light-source mechanism, and a rear reflective member. The bending formation mechanism holds an optical fiber and forms the bent portion. The fiber feeding mechanism feeds the optical fiber toward the bending formation mechanism. The light-source mechanism includes a light source and emits a laser beam to a portion of the whole periphery of the optical fiber. The rear reflective member is disposed at a position facing the light source across the optical fiber, which is fed toward the bending formation mechanism.

The manufacturing apparatus according to the present invention may further include a side reflective member that is disposed at a position facing an outer peripheral side surface of the optical fiber, which is sent out. The optical fiber, which is sent out, may be included in a plurality of the optical fibers arranged side by side, and the manufacturing apparatus according to the present invention may include the side reflective member provided between adjacent ones of the plurality of optical fibers. The light-source mechanism may include a laser-scanning unit that causes the laser beam to scan in a direction crossing a direction in which the optical fiber is sent out.

A method according to the present invention for manufacturing a bent optical fiber that includes a bent portion in which bending stress has been decreased includes forming a bent portion by causing stress to be generated in an optical fiber that has been sent out in a predetermined direction and emitting a laser beam from a light source that is disposed at a predetermined position toward a position at which the stress is generated in the optical fiber. Some of the laser beam emitted by the light source is reflected by a reflective member that is disposed in the vicinity of the optical fiber, which is sent out, and is oriented toward the optical fiber.

According to the apparatus and the method for the present invention for manufacturing a bent optical fiber that includes a bent portion in which bending stress has been decreased, the possibility of variations occurring in the quality of a bent optical fiber can be reduced.

### BRIEF DESCRIPTION OF THE DRAWINGS

FIG. 1 is a conceptual diagram illustrating an apparatus for manufacturing a bent optical fiber according to an aspect of the present invention.

FIG. 2 is a conceptual diagram illustrating a state where optical fibers are sandwiched by a fiber feeding mechanism in the apparatus for manufacturing a bent optical fiber illustrated in FIG. 1.

FIG. 3 is a conceptual diagram illustrating a bending formation mechanism in the apparatus for manufacturing a bent optical fiber illustrated in FIG. 1.

FIG. 4 is a diagram illustrating a bending process in a method for manufacturing a bent optical fiber according to the aspect of the present invention.

FIG. 5 is a diagram illustrating a first embodiment of a reflective member in the apparatus for manufacturing a bent optical fiber illustrated in FIG. 1.

FIG. 6 is a diagram illustrating a second embodiment of the reflective member in the apparatus for manufacturing a bent optical fiber illustrated in FIG. 1.

FIG. 7 is a diagram illustrating a third embodiment of the reflective member in the apparatus for manufacturing a bent optical fiber illustrated in FIG. 1.

FIG. 8 is a diagram illustrating a fourth embodiment of the reflective member in the apparatus for manufacturing a bent optical fiber illustrated in FIG. 1.

### DESCRIPTION OF THE PREFERRED EMBODIMENTS

A preferred embodiment of an apparatus according to the present invention for manufacturing a bent optical fiber and a preferred embodiment of a method according to the present invention for manufacturing a bent optical fiber will be described below with reference to the accompanying drawings.

When an optical fiber is bent by using an infrared laser beam, it is desired to make the temperature distribution between an irradiated surface of the optical fiber that is irradiated with the laser beam and a rear surface of the optical fiber that is opposite to the irradiated surface uniform. More specifically, silica glass included in an optical fiber has a transmittance of 1% or lower in the mid-infrared region (2.5 μm to 4.0 μm) and in the far-infrared region (4 μm to 1,000 μm). In other words, most of the laser beam is absorbed by the irradiated surface, and the laser beam is unlikely to reach the rear surface (the surface on the side on which shadow is generated), which is opposite to the irradiated surface. Thus, a temperature gradient occurs in which the temperature decreases from the irradiated surface toward the rear surface. Consequently, there is a case where the irradiated surface becomes softer than the rear surface and is stretched, which in turn results in a reduction in the diameter of the optical fiber. There is another case where, when the temperature of the rear surface becomes lower than the temperature of the irradiated surface, and the rear surface does not bend at a constant curvature or deformation occurs in the rear surface, this causes a bending failure and a loss increase.

In order to densely mount electronic components that are used for optical communication, there is an optical connecting component in which a plurality of bent optical fibers are arranged side by side (also called a fiber array). In this case, when an infrared laser beam is radiated onto the component, the optical fiber that is positioned in the middle receives radiant heat from the adjacent optical fibers as well as the laser beam. In contrast, the optical fibers that are positioned at the both sides are less likely to receive radiant heat from the adjacent optical fibers. Thus, a temperature gradient occurs in which the temperature decreases from the optical fiber positioned in the middle toward the optical fibers positioned at the both sides. It is desired to make the temperature distribution between the optical fiber positioned in the middle and the optical fibers positioned at the both sides uniform.

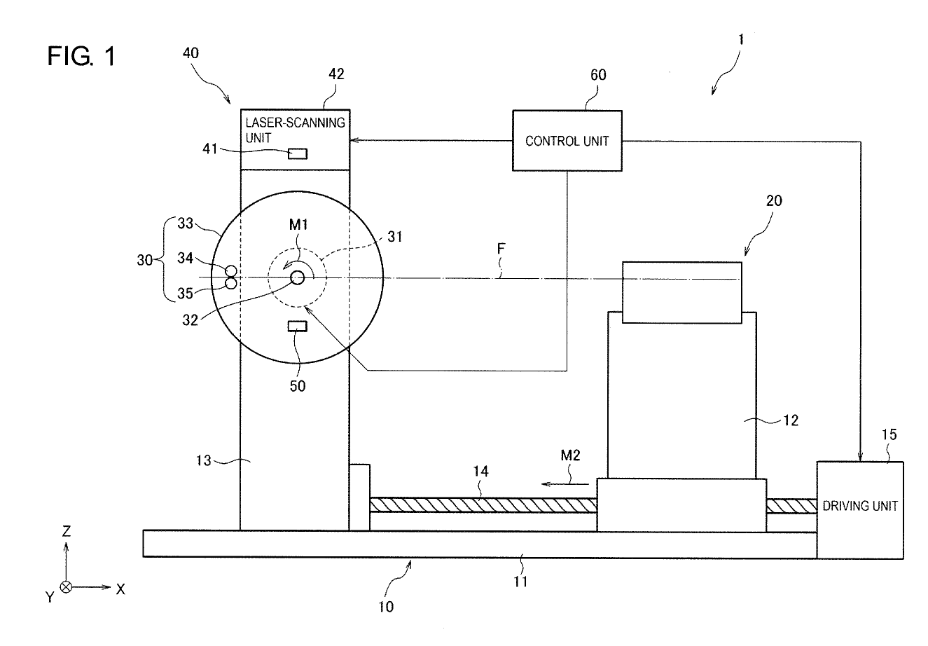

FIG. 1 is a conceptual diagram illustrating a manufacturing apparatus 1 according to an aspect of the present invention for manufacturing a bent optical fiber. The manufacturing apparatus 1 includes a work stage 10, a fiber feeding mechanism 20, a bending formation mechanism 30, a light-source mechanism 40, a rear reflective member 50, and a control unit 60.

The work stage 10 includes a base 11 having a flat plate-like shape, a holder 12, and a support 13. The fiber feeding mechanism 20 is mounted on the holder 12, and the bending formation mechanism 30, the light-source mechanism 40, and the rear reflective member 50 are mounted on the support 13. The support 13 is fixed to the base 11, whereas the holder 12 is capable of moving with respect to the base 11. More specifically, the holder 12 and the support 13 are connected to each other by a rail 14 extending in the X-axis direction in FIG. 1, and the rail 14 is rotatably supported by the support 13 and, on the other hand, engages with a thread groove of the holder 12 while extending through the holder 12. Thus, when the rail 14 is caused by a driving unit 15 to rotate in a predetermined direction, the holder 12 moves along the rail 14 in the direction of arrow M2 in FIG. 1 (the negative X-axis-direction) toward the support 13.

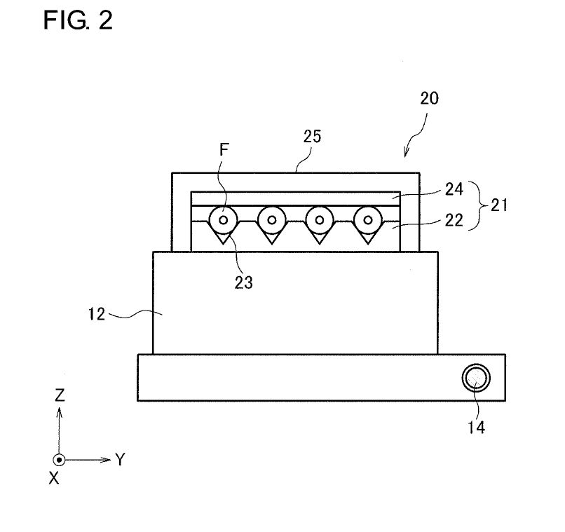

FIG. 2 is a diagram illustrating a state where optical fibers are sandwiched by the fiber feeding mechanism 20 in the manufacturing apparatus 1 for manufacturing a bent optical fiber when viewed from the driving unit 15 (when viewed from the rear side of the manufacturing apparatus 1). The fiber feeding mechanism 20 includes a fiber anchoring component 21 that holds trailing ends of optical fibers F. Note that a connector can be provided at leading ends of the optical fibers F that are opposite to the trailing ends of the optical fibers F.

The fiber anchoring component 21 includes a V-grooved substrate 22 and a lid 24, and the V-grooved substrate 22 is placed on the holder 12 in a state where V-grooves 23 are open upward (in the positive Z-axis-direction in FIG. 2). The V-grooves 23 are formed in the X-axis direction, and the optical fibers F can be supported in the V-grooves 23. Note that, for example, four V-grooves 23 according to the present embodiment are formed and arranged in the Y-axis direction in FIG. 2.

The lid 24 is formed in a flat plate-like shape and covers the V-grooves 23 so as to restrict upward movement of the optical fibers F. The fiber anchoring component 21 holding the trailing ends of the optical fibers F is fixed to the holder 12 with a fixing jig 25. Each of the optical fibers F is made of silica-based glass and includes a core and a clad, and for example, four optical fibers F each extending in the X-axis direction in FIG. 2 are arranged in the Y-axis direction in FIG. 2. In at least a region of each of the optical fibers F in which a bent portion is to be formed, a resin coating layer coating a glass portion is removed beforehand.

Note that each of the optical fibers F may be a single-core optical fiber that includes a single core or may be a multicore optical fiber that includes a plurality of cores. In addition, in the present embodiment, although a case has been described in which the four optical fibers F are arranged in the Y-axis direction, for example, one optical fiber F may be fed toward the bending formation mechanism 30.

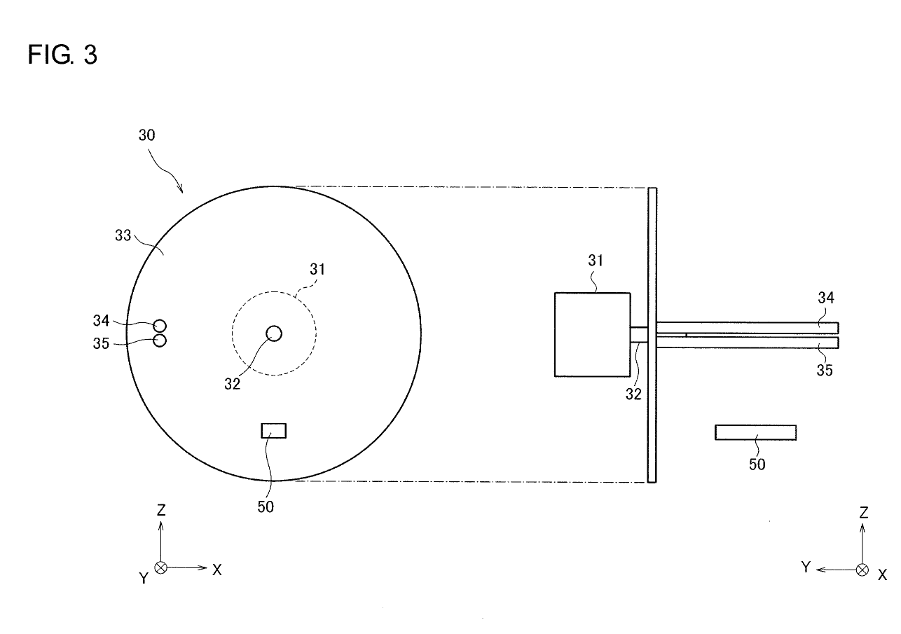

FIG. 3 is a diagram illustrating the bending formation mechanism 30 in the manufacturing apparatus 1 for manufacturing a bent optical fiber. The left half of FIG. 3 illustrates the bending formation mechanism 30 when viewed from the negative Y-axis-direction as in FIG. 1. The right half of FIG. 3 illustrates the bending formation mechanism 30 when viewed from the front of the manufacturing apparatus 1 (when viewed from the negative X-axis-direction). The bending formation mechanism 30 includes a motor (e.g., a stepping motor) 31, and a rotary shaft 32 of the motor 31 extends in the Y-axis direction in FIG. 3 and is rotatably supported by the support 13 illustrated in FIG. 1.

The rotary shaft 32 is integrally formed with a support plate 33 that has a circular shape, and a pair of bending levers 34 and 35 are fixed to the support plate 33. More specifically, the bending levers 34 and 35 are each formed in, for example, a round bar-like shape and arranged on a surface of the support plate 33 so as to extend in the Y-axis direction in FIG. 3. The bending lever 34 and the bending lever 35 are disposed with a gap therebetween, and the optical fibers F can be held in the gap. An intermediate point in the gap corresponds to, for example, a feeding position of the optical fibers F. Note that it is preferable that the gap be two times or more and four times or less the outer diameter of the clad of each of the optical fibers F, and the gap is preferably, for example, 500 μm or less.

As illustrated in FIG. 1, the light-source mechanism 40 is provided at an upper portion of the support 13. The light-source mechanism 40 includes a light source 41 and a laser-scanning unit 42. The light source 41 is capable of emitting a laser beam in the near-infrared region having a wavelength of, for example, 1.5 μm or more, and the laser-scanning unit 42 is capable of scanning in a direction in which the optical fibers F are arranged (the Y-axis direction in FIG. 1). Note that the bent portions may be formed by using a laser beam in the mid-infrared region or a laser beam in the far-infrared region.

In contrast, the rear reflective member 50 is disposed at a position facing the light source 41 with the optical fibers F interposed therebetween. This enables the rear reflective member 50 to reflect some of the laser beam emitted by the light source 41 and to cause the reflected laser beam to be oriented toward the rear surfaces of the optical fibers F. Note that it is preferable that the rear reflective member 50 be made of a material (e.g., gold, silver, or aluminum) that has excellent durability and high reflectivity with respect to the wavelength of a laser beam in the near-infrared region. In addition, it is preferable that a surface of the rear reflective member 50 be rough and have a shape capable of realizing diffuse reflection, or it is preferable that the surface of the rear reflective member 50 be a mirror and have a shape capable of realizing specular reflection.

The control unit 60 includes a central processing unit (CPU), memory, and so forth, and can output signals to the driving unit 15, the motor 31, and the light-source mechanism 40 by loading various programs and data stored in, for example, read only memory (ROM), which is included in the memory, into random access memory (RAM) and executing the various programs, so as to control the operation of the manufacturing apparatus 1.

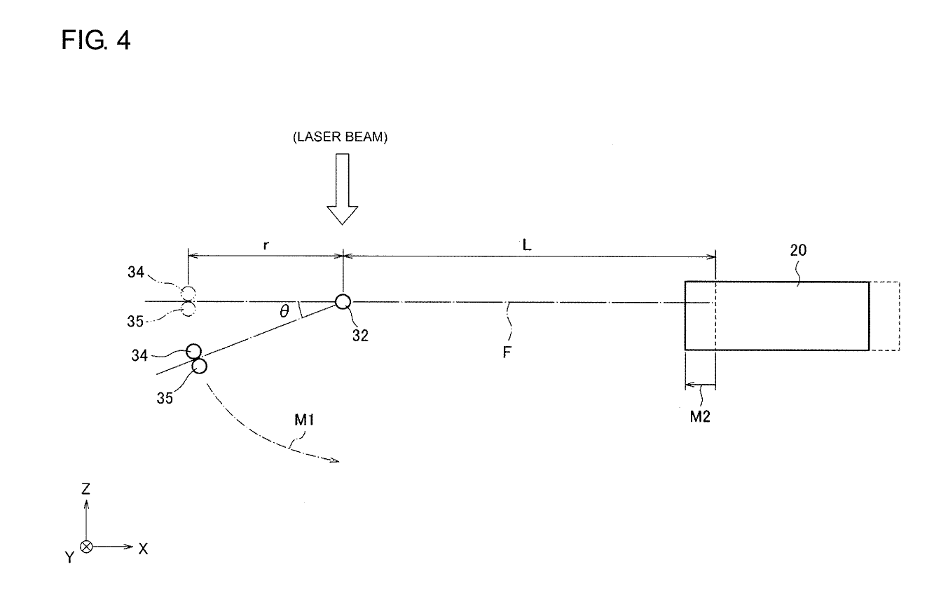

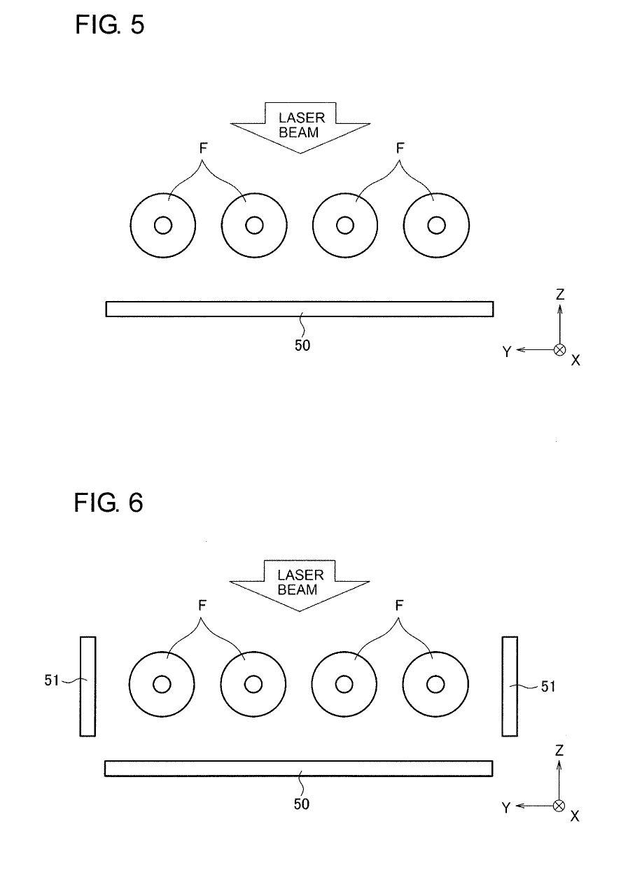

FIG. 4 is a diagram illustrating a bending process in a method according to another aspect of the present invention for manufacturing a bent optical fiber, and FIG. 5 is a diagram illustrating a first embodiment of the reflective member in the manufacturing apparatus 1 for manufacturing a bent optical fiber. As illustrated in FIG. 4, the distance from an end surface of the fiber anchoring component 21 that is located on the side on which the bending formation mechanism 30 is disposed to the axis of the rotary shaft 32 will be referred to as a distance L, and the distance from the axis of the rotary shaft 32 to an intermediate point between the bending levers 34 and 35 (the above-mentioned intermediate point in the gap) will be referred to as a distance r.

Portions of the optical fibers F are sandwiched between the bending lever 34 and the bending lever 35, and the motor 31 is caused to rotate in the direction of arrow M1 in FIG. 4. More specifically, the bending levers 34 and 35 are rotated in the same direction about the rotary shaft 32 by an angle θ (e.g., five degrees or less is preferable) with respect to a direction in which the optical fibers F are sent out (the negative X-axis-direction in FIG. 4) such that stress is generated in portions of the optical fibers F (tensile stress is generated in irradiated surfaces of the optical fibers F, which will be described later, and compressive stress is generated in rear surfaces of the optical fibers F). In this case, however, the bent portions of the optical fibers F may sometimes be offset downward from an extension line of the axis of the rotary shaft 32 (an imaginary line parallel to the Y-axis).

Accordingly, when the fiber anchoring component 21 is moved by a certain distance in the direction of arrow M2 in FIG. 4, the portions of the optical fibers F, in which the stress has been generated, are caused to move so as to be on the extension line of the axis of the rotary shaft 32. After that, the laser beam is radiated onto the portions of the optical fibers F on the extension line of the axis of the rotary shaft 32 by using the light-source mechanism 40 and the rear reflective member 50.

More specifically, as illustrated in FIG. 5, when the laser beam is radiated from a position above the optical fibers F, each of the optical fibers F is directly irradiated by the light source 41 and is heated from all directions by the laser beam including some of the laser beam reflected by the rear reflective member 50 and heat rays heating the adjacent optical fibers F. Note that, as a result of heating the optical fibers F by using the laser beam, the stress generated in the bent portions can also be reduced. Subsequently, generation of stress in the optical fibers F, feeding of the optical fibers F, and radiation of the laser beam are repeated, so that the bent portions can be formed in the optical fibers F.

As described above, since the laser beam from the light-source mechanism 40 is radiated onto the optical fibers F that are sent out and is also reflected by the rear reflective member 50 so as to be radiated onto the rear surfaces of the optical fibers F (the surfaces on the side on which shadow is generated when viewed from the light source 41), when the bent portions are formed by using a laser beam in the near-infrared region, the temperature distribution between the irradiated surfaces and the rear surfaces is uniform. As a result, the possibility of variations occurring in the quality of a bent optical fiber can be reduced.

In addition, by causing the laser beam to scan in the direction in which the optical fibers F are arranged, an irradiation range of the laser beam can be expanded. In particular, even in the case where the optical fibers F are sent out in the form of a fiber array, the temperature distribution between the optical fiber F that is positioned in the middle and the optical fibers F that are positioned at the both sides can be made uniform.

FIG. 6 is a diagram illustrating a second embodiment of the reflective member in the manufacturing apparatus 1 for manufacturing a bent optical fiber. In addition to the rear reflective member 50, which is disposed at a position facing the light source 41 with the optical fibers F interposed therebetween, side reflective members 51 may be provided at positions facing the outer peripheral side surfaces of the optical fibers F that are positioned at the both sides. As a result, the rear reflective member 50 reflects some of the laser beam emitted by the light source 41 and causes the reflected laser beam to be oriented toward the rear surfaces of the optical fibers F, and also the side reflective members 51 can reflect some of the laser beam emitted by the light source 41 and cause the reflected laser beam to be oriented toward the outer peripheral side surfaces of the optical fibers F. In this manner, some of the laser beam from the light-source mechanism 40 is reflected by the side reflective members 51 and radiated also onto the outer peripheral side surfaces of the optical fibers F, and thus, the temperature distribution between the irradiated surfaces and the outer peripheral side surfaces can be made uniform.

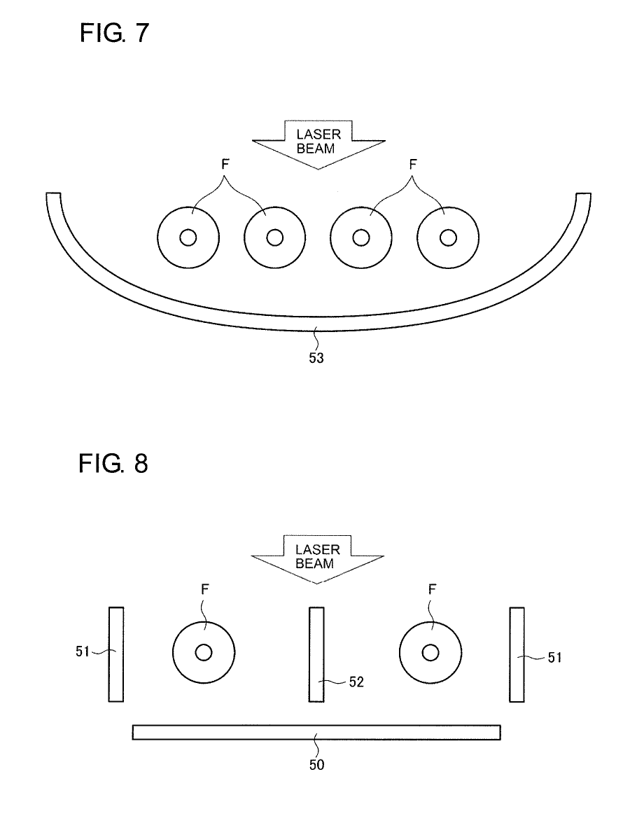

FIG. 7 is a diagram illustrating a third embodiment of the reflective member in the manufacturing apparatus 1 for manufacturing a bent optical fiber. The rear reflective member 50 may be formed so as to have any of a flat surface, a concave surface, and a convex surface. Note that, in the case where the rear reflective member 50 has a convex surface, a high-temperature region that is likely to be unevenly distributed to the optical fiber F that is positioned in the middle can be distributed to the optical fibers F that are positioned at the both sides. In addition, in the case where the rear reflective member 50 has a concave surface having a curvature that is sufficiently small with respect to the optical fibers F, the rear reflective member 50 can have a function of serving as both a rear reflective member and a side reflective member like a rear reflective member 53 that is illustrated in FIG. 7.

FIG. 8 is a diagram illustrating a fourth embodiment of the reflective member in the manufacturing apparatus 1 for manufacturing a bent optical fiber. In the first to third embodiments, although a case has been assumed in which the distance between adjacent optical fibers F is small, there is a case where the distance between adjacent optical fibers F is large and where each of the optical fibers F is unlikely to receive radiant heat from the adjacent optical fibers F. In this case, side reflective members 52 may be provided between the outer peripheral side surfaces of adjacent ones of the optical fibers F. As a result, each of the side reflective members 52 can reflect some of the laser beam emitted by the light source 41 and cause the reflected laser beam to be oriented toward the outer peripheral side surfaces of the corresponding adjacent optical fibers F. Note that it is preferable that each of the side reflective members 51 and 52 have a concave surface in order to make it easier to cause the reflected laser beam to be oriented toward the optical fibers F.

In the first to fourth embodiments, a case has been described as an example in which the light-source mechanism 40 is provided at the upper portion of the support 13 and in which the rear reflective member 50 is provided below the optical fibers F. However, the light-source mechanism 40 may be provided below the optical fibers F, and the rear reflective member 50 may be provided at an upper portion of the support 13. In this case, if the optical fibers F are sandwiched between the bending levers 34 and 35, the motor 31 is caused to rotate in a direction opposite to the direction of arrow M1 in FIG. 4, and the fiber anchoring component 21 is moved in a direction opposite to the direction of arrow M2 in FIG. 4, the optical fibers F will be positioned on the extension line of the axis of the rotary shaft 32.

The embodiments disclosed herein are examples in all respects, and the present invention is not to be considered limited to the embodiments. The scope of the present invention is to be determined not by the above-described meanings, but by the claims, and it is intended that meanings equal to the claims and all the modifications within the scope of the claims are included in the scope of the present invention.

What is claimed is:

1. A manufacturing apparatus for manufacturing a bent optical fiber that includes a bent portion in which bending stress has been decreased, the manufacturing apparatus comprising:
a bending formation mechanism that holds an optical fiber and forms the bent portion;
a fiber feeding mechanism that feeds the optical fiber toward the bending formation mechanism;
a light-source mechanism that includes a light source that emits a laser beam to a portion of a whole periphery of the optical fiber; and
a rear reflective member facing the light source across the optical fiber, which is fed toward the bending formation mechanism.

2. The manufacturing apparatus according to claim 1, further comprising:
a side reflective member that is disposed at a position facing an outer peripheral side surface of the optical fiber, which is sent out.

3. The manufacturing apparatus according to claim 2,
wherein the optical fiber, which is sent out, is included in a plurality of the optical fibers arranged side by side, and
wherein the side reflective member is provided between adjacent ones of the plurality of optical fibers.

4. The manufacturing apparatus according to claim 1,
wherein the light-source mechanism includes a laser-scanning unit that causes the laser beam to scan in a direction crossing a direction in which the optical fiber is sent out.

5. The manufacturing apparatus according to claim 2,
wherein the light-source mechanism includes a laser-scanning unit that causes the laser beam to scan in a direction crossing a direction in which the optical fiber is sent out.

6. The manufacturing apparatus according to claim 3,
wherein the light-source mechanism includes a laser-scanning unit that causes the laser beam to scan in a direction crossing a direction in which the optical fiber is sent out.

7. A method for manufacturing a bent optical fiber that includes a bent portion in which bending stress has been decreased, the method comprising:
forming a bent portion by causing stress to be generated in an optical fiber that has been sent out in a predetermined direction; and
emitting a laser beam from a light source that is disposed at a predetermined position toward a position at which the stress is generated in the optical fiber,
wherein some of the laser beam emitted by the light source is reflected by a reflective member that is disposed in the vicinity of the optical fiber, which is sent out, and is oriented toward the optical fiber.
